(19) United States
(12) Patent Application Publication
(10) Pub. No.: US 2025/0297502 A1
(43) Pub. Date: Sep. 25, 2025

(54) VEHICLE DOOR LOCKING EQUIPMENT

(71) Applicant: Minebea AccessSolutions France, Alfortville (FR)

(72) Inventors: François DEBROUCKE, Alfortville (FR); Jean-Baptiste GRISAIN, Alfortville (FR); Jean-Philippe HOCHART, Alfortville (FR)

(73) Assignee: Minebea AccessSolutions France, Alfortville (FR)

(21) Appl. No.: 19/079,822

(22) Filed: Mar. 14, 2025

(30) Foreign Application Priority Data
Mar. 20, 2024 (EP) 24315099

(51) Int. Cl. E05B 85/04; E05B 77/30; E05B 83/36

(52) U.S. Cl. CPC E05B 85/04; E05B 77/30; E05B 83/36

(57) ABSTRACT

Vehicle door locking equipment includes a door latch, a lock cylinder for locking or unlocking a vehicle door by rotating a control paddle linked to the door latch, an inner handle linked to the door latch to be rotated to allow an opening of the door from inside a passenger cabin, a stopper knob located inside the passenger cabin, and a stopper to be displaced between a first position allowing rotation of the control paddle and a second position allowing rotation of the control paddle upon actuation of the stopper knob. The inner handle is arranged to displace the stopper in the first position when the inner handle is rotated to open the door.

### TECHNICAL FIELD

The present invention relates to the field of vehicle door locking equipments to control the locking and unlocking of the vehicle door from inside in order to prevent the opening of the door from the outside. The invention also relates to a vehicle door comprising such locking equipment.

### BACKGROUND OF THE INVENTION

It is known from the state of the art, to provide a night lock system for a vehicle door which prevents break-ins, theft or invasion of the privacy of a driver inside the vehicle. The night lock system comprises a mechanical lock, in general a hardened pin, which can be mounted on an inner panel of the door. When activated, the mechanical lock blocks the door, preferably by inserting the pin around or into the armrest of the door, to prevent someone else from opening the door from outside.

However, such a night lock system is usually sold separately, in preference as an accessory which can be mounted on the door panel by the driver himself, and can require specific interfaces to be correctly installed.

Such a night lock system is usually appreciated in a double-crew vehicle, advantageously heavy-duty trucks, wherein the truck drivers take turn to rest inside the vehicle when said vehicle is required to stay stationary.

In general, both drivers have an authorised key adapted to open the vehicle door. At times, it may occur that one driver is resting inside the vehicle while the other driver uses his authorised key and by mistake invades the privacy of the resting one.

Since this night lock is not connected to the latching mechanism of the door, if not installed correctly, the risk of violation remains.

It is also known to provide for an inner door handle frame in a vehicle door, the frame supports an inner door handle which can be rotated to open the door from inside, and a key button which can be manually actuated to prevent unintentional opening of the door from inside the passenger cabin as well as intentional opening of the door by rotation of an outer door handle.

However, in such conventional configurations, the key button only blocks the latching system of the door and thus only prevents opening of the door by one of the inner or outer door handles. Someone who is in possession of an authorized key can unblock the latching system from outside to allow opening of the door using the outer door handle. Therefore, the risk of invasion still persists.

Another risk with the use of such a key button is to forget to unlock the key button when the user exits the cabin so that the user may be locked outside the vehicle with no way to enter the vehicle as the key button is in a locked position.

The purpose of the invention is to provide a vehicle door locking mechanism which is integrated in the vehicle door latching mechanism, to prevent the opening or mechanically unlocking of the vehicle from outside, even in case an individual is in possession of an authorized key to unlock the door and which prevents the risk of being locked outside the vehicle inadvertently when the user exits the cabin without unlocking the key button.

### SUMMARY OF THE INVENTION

The present invention refers to a vehicle door locking equipment comprising:
a door latch,
a lock cylinder for locking or unlocking a vehicle door by rotating a control paddle linked to the door latch,
an inner handle linked to the door latch and configured to be rotated to allow an opening of the door from inside a passenger cabin,
a stopper knob located inside the passenger cabin,
a stopper configured to be displaced between a first position allowing rotation of the control paddle and a second position allowing rotation of the control paddle upon actuation of the stopper knob,
   wherein the inner handle is configured to displace the stopper in the first position when the inner handle is rotated to open the door.

The use of an inner handle that displaces the stopper in the first position when the inner handle is rotated to open the door ensures that the stopper is not in the locking position when the user exits his/her cabin which therefore avoids the user to be locked outside his/her cabin with no solution to enter the cabin even if he/she has an authorized key.

According to another aspect of the present invention, the stopper knob comprises an actuation lever which is displaced between a first position associated to the first position of the stopper and a second position associated with the second position of the stopper and wherein inner handle is configured to displace the actuation lever towards its first position when the inner handle is rotated to open the door.

According to another aspect of the present invention, the rotation of the inner handle is configured to displace the stopper in the first position before unlocking the latch and opening the door.

According to another aspect of the present invention, the inner handle is provided on an inner door handle frame and the stopper knob is arranged in the inner door handle frame.

According to another aspect of the present invention, the door latch comprises a control lever for unlocking the latch, the control lever is linked to the control paddle of the lock cylinder and the stopper is in contact of the latch in said second position.

According to another aspect of the present invention, the door latch and the stopper are housed in a common housing.

According to another aspect of the present invention, the control lever rotates according to a rotational axis, the stopper is configured to be displaced along a linear pathway which is substantially perpendicular to the rotational axis of the control lever.

According to another aspect of the present invention, the stopper comprises a blocking end which is configured to intercept the control lever of the latch in said second position.

The present invention also refers to a vehicle door comprising a vehicle door locking equipment as described previously.

According to another aspect of the present invention, the door is a side door.

### BRIEF DESCRIPTION OF THE DRAWINGS

The invention will be better understood and other characteristics and advantages will appear at the reading of the following description, given in an illustrative and non-limiting fashion, referring to the annexed figures in which,

FIG. 1a is an inside view of a vehicle door comprising a vehicle door locking mechanism,

FIG. 1b is a zoomed view of the inner door handle frame of the vehicle door in FIG. 1,

FIG. 2 is an exploded view of a similar vehicle door comprising an exemplary embodiment of the present disclosure,

FIG. 3 is a perspective view of a stopper in contact with a control lever of a door latch according to an exemplary embodiment of the present invention,

FIG. 4a and 4b are perspective views of a stopper in contact with a control lever of a door latch according to the clockwise or anti-clockwise rotation of the control lever,

FIG. 5a, 5b and 5c represent diagrams of the vehicle inner door handle and the knob button of the door locking equipment in different positions.

FIG. 6 is a diagram of the evolution of the state of the different locking mechanisms when the inner handle is rotated.

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

The present invention refers to a vehicle door locking equipment that can be locked from the inside.

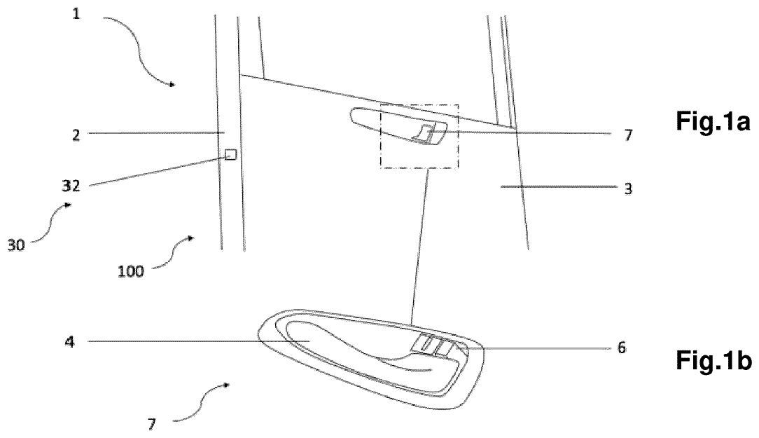

A vehicle door locking equipment 100 will be described with reference to FIGS. 1a to 4b. The vehicle door locking equipment 100 is provided inside a vehicle door 1 of a vehicle as illustrated in FIG. 1a, for example a truck door or an automobile vehicle door. The door may be a side door.

The present invention is in particular appreciated in a double-crew vehicle wherein at least two drivers have an authorized key. In the present description, it is understood that an authorized key can be a mechanical and/or an electronic key with remote control or handless access. The vehicle door locking equipment 100 is configured to prevent one driver from invading the privacy of the other driver who is resting inside the passenger cabin although he has an authorized key.

The vehicle door 1 in FIG. 1a, comprises an outer panel 2 and an inner panel 3 between which the vehicle door locking equipment 100 is arranged. In this view, the vehicle door locking equipment 100 is only partially visible.

FIG. 1a partially shows a door latch 30 comprising a rotary latch fork 32 provided on a lateral side of the vehicle door 1, said latch fork 32 can rotate in a way to be reversibly engaged in a not shown striker formed on a door frame of the vehicle door 1 for opening or closing the door 1. The latch fork 32 can be actuated by an inner door handle 4 (visible in FIG. 1b) or an outer door handle 5 (not visible on FIG. 1a).

FIG. 1b shows an isolated enlarged view of an inner door handle frame 7 from FIG. 1a. The inner door handle frame 7 supports the inner handle door 4. In particular, a kinematic lever is provided on the inner door handle frame 7. The kinematic lever can be the inner door handle 4 provided on the inner door handle frame 7. The kinematic lever is linked to the door latch 30 to allow opening of the vehicle door 1 from inside the passenger cabin by rotation of the inner door handle 4. The kinematic lever can be linked to the door latch 30 via a Bowden cable or any other suitable mechanical link.

When the latch fork 32 is engaged in the striker, the door 1 is maintained closed, and when either one of the door handles 4, 5 is rotationally actuated, the latch fork 32 is released from the striker to allow an opening of the door 1.

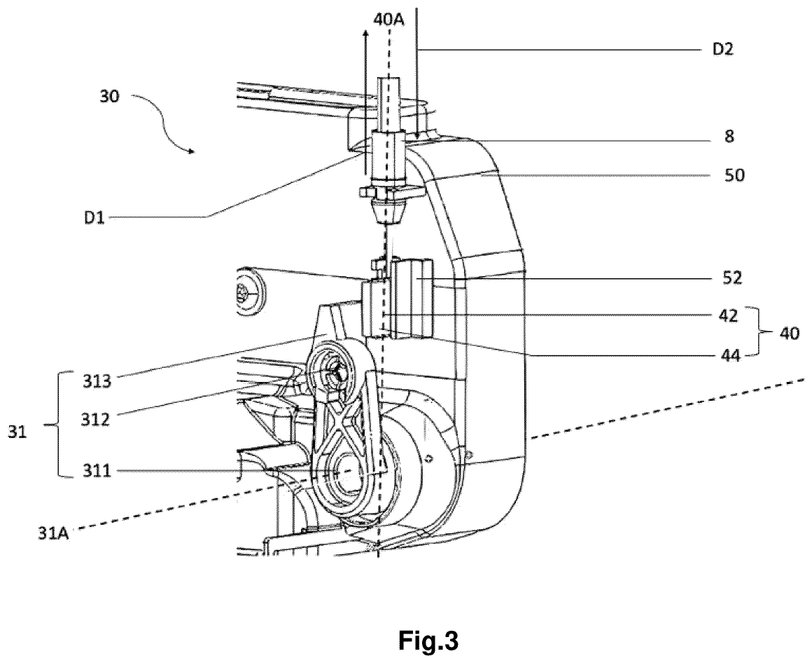

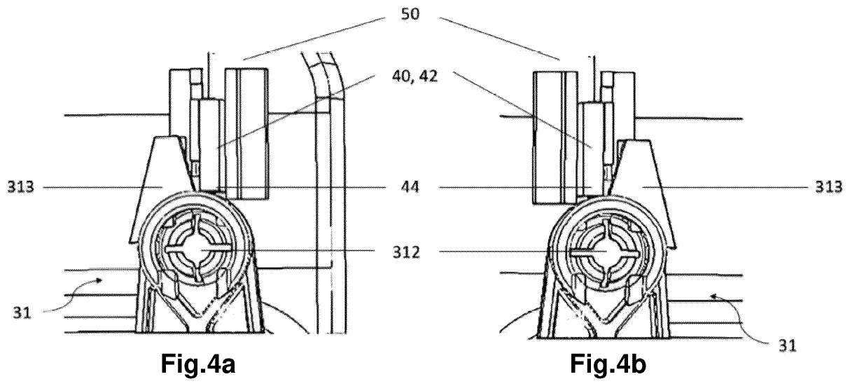

The inner door handle frame 7 also supports a stopper knob 6 of a displaceable stopper 40 (the stopper is shown in more details in FIGS. 3, 4a and 4b). The stopper knob 6 can be manually actuated to block the release of the latch fork 32 thus preventing opening of the vehicle door 1 from outside and to prevent unlocking of the vehicle door 1 even when an authorized key is used. This operation will be further described in the following paragraphs. The stopper knob 6 comprises for example a pivoting knob. The stopper knob 6 may then be rotated between an unlocked position wherein the door 1 can be unlocked with an authorized key and a locked position wherein the door 1 cannot be unlocked by an authorized key.

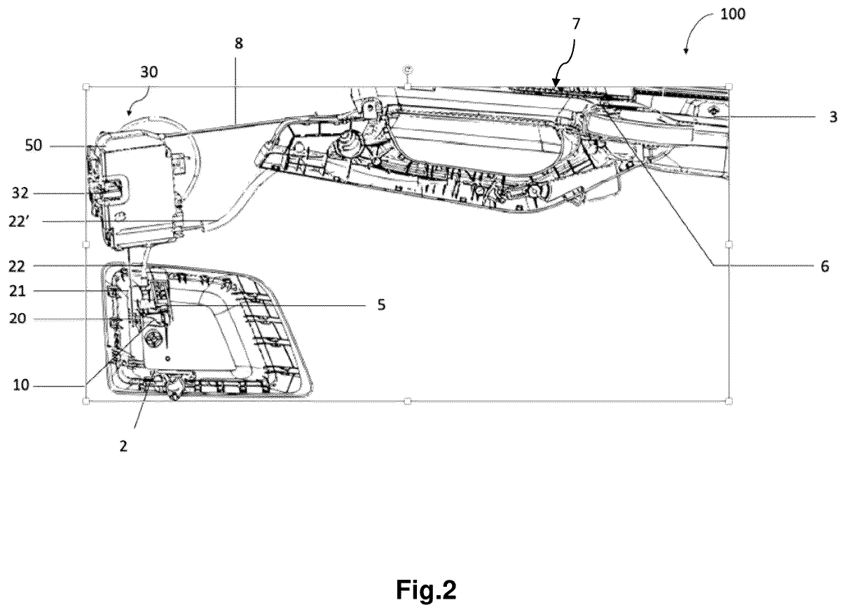

FIG. 2 illustrates an exemplary embodiment of the vehicle door locking equipment 100 arranged between the outer panel 2 and the inner panel 3 of the vehicle door 1. The vehicle door locking equipment 100 comprises a lock cylinder 10, a control paddle 20, a door latch 30 and the inner door handle frame 7.

In particular, only part of the outer panel 2 is shown supporting the lock cylinder 10 and the outer door handle 5, meanwhile the inner door handle frame 7 supporting the inner door handle 4 and the stopper knob 6 is not clearly visible but it can be visualized on FIG. 1b.

The lock cylinder 10 includes an inner face which is connected to the control paddle 20, it also includes an outer face provided with a key hole not visible on the FIG. 2. The key hole is accessible from the outer panel 2, that is from outside, to allow introduction of an authorized key which can be rotated to actuate the rotation of the control paddle 20 for locking or unlocking of the vehicle door 1.

In FIG. 2, the door latch 30 is represented with the latch fork 32 mounted in a housing 50.

The control paddle 20 is mechanically linked to the door latch 30 in a rotational manner by means of a rod 21. Hence, a mechanical connection is established between the control paddle 20 and the door latch 30 to allow locking or unlocking of said door latch 30. Locking of the door latch 30 prevents either one of the handles 4, 5 from releasing the latch fork 32 to open the vehicle door 1.

The outer door handle 5 and the inner door handle frame 7, more specifically the inner door handle 4, are each linked to the door latch 30 by means of a Bowden cable 22, 22′. The Bowden cables 22, 22′ allow establishing a mechanical connection between each of the handles 4, 5 and the door latch 30 so as to be able to actuate release of the latch fork 32 upon rotation of either one of the handles 4,5 for opening the vehicle door 1. The inner 4 and outer 5 door handles can be linked to the door latch 30 by other suitable mechanical means.

Furthermore, the inner door handle frame 7 is connected to the housing 50 of the door latch 30 by means of a stopper Bowden cable 8. More specifically, the stopper Bowen cable 8 connects the stopper knob 6 shown in FIG. 1, to a stopper 40 (visible in FIGS. 3, 4a and 4b).

The stopper 40 is advantageously arranged to block the rotation of the control paddle 20 to prevent opening of the vehicle door 1 from outside. This operation will be better explained in the following paragraphs.

Referring to FIG. 3, the door latch 30 comprises a control lever 31 for unlocking the latch 30. The control lever 31 is linked to the control paddle 20 of the lock cylinder 10 by means of the rod 21 shown in FIG. 2.

The control lever 31 is mounted on the housing 50 of the door latch 30 for controlling the unlocking of said latch 30. By unlocking the door latch 30, the latch fork 32 shown in FIGS. 1a and 2, can be released from the striker to allow opening of the vehicle door 1 by rotation of either one of the inner 4 or outer 5 door handles.

More specifically, the control lever 31 presents a base body 311 pivotably mounted on the housing 50 of the door latch 30. The base body 311 comprises a distal end provided with a port 312 into which one end of the rod 21 shown in FIG. 2 can be engaged to cause rotation of the control lever 31. The control lever 31 can rotate according to a rotational axis 31A to allow unlocking of the door latch 30. Such a rotation may generate a torque to unlock the door latch 30.

Therefore, upon rotation of the control paddle 20, the control lever 31 can also be rotated according to its rotational axis 31A for unlocking the door latch 30.

FIG. 3 also shows the stopper 40 mentioned above, which is placed between the outer panel 2 and inner panel 3 of the vehicle door 1. The stopper 40 is mounted in a way to be moved between a first and a second position. In particular, the first position where the stopper is pulled in direction D1, allows rotation of the control paddle 20, and the second position which is shown in FIG. 3 and corresponds to a pushed position in a direction D2, blocks the rotation of the control paddle 20 to prevent opening of the vehicle door 1 from the outside. This operation is going to be further explained in the following paragraphs.

The stopper knob 6 shown in FIG. 1 is connected to the stopper 40 by means of the stopper Bowden cable 8 shown in FIG. 2. Upon actuation of the stopper knob 6, a traction or a push is applied by the Bowden cable 8 on the stopper 40 which becomes resiliently biased between the first position and the second position or inverse to allow displacement of the stopper 40.

As shown in FIG. 3, the stopper 40 is configured to be displaced along a linear pathway 40A which is substantially perpendicular to the rotational axis 31A of the control lever 31. The stopper 40 can be displaced along guide rails 52 provided on the housing 50, between the first and second positions.

By housing the stopper 40 in the same housing 50 as the door latch 30 and thanks to its linear perpendicular pathway, the stopper 40 is able to interact directly with the control lever 31 in order to intercept its rotational pathway. Therefore, there is no need to use any additional safety lock, such as an additional night lock, when a driver wants to keep his privacy.

The stopper 40 preferably presents a parallelepiped flat block 42 which can be displaced along the guide rails 52 in the shape of ribs. The flat block 42 presents a blocking end 44 which is configured to intercept the control lever 31 of the door latch 30 in the second position. FIG. 3 shows the stopper 40 in the second position wherein said stopper 40 is placed in contact with the control lever 31.

The control lever 31 comprises a distal end provided with a blocking extension 313 which extends towards the stopper 40. The blocking end 44 of the stopper 40 is configured to intercept a blocking extension 313 formed on the control lever 31.

Thanks to the interaction with the distal blocking extension 313 of the control lever 31, the blocking end 44 of the stopper 40 is able to counteract the rotational force of the control lever 31 by carrying out minimal work.

By being in contact with the control lever 31, the stopper 40 can provide a resistive force to counteract the rotative force of the control lever 31 in order to block the rotation of the control lever 31 preventing it from unlocking the door latch 30 and hence to prevent opening of the vehicle door 1 when the outer handle 5 is actuated.

By blocking the rotation of the control lever 31, the stopper 40 can also indirectly block the rotation of the control paddle 20 due to the mechanical connection established by the rod 21 shown in FIG. 2. Therefore, even though an authorized key is introduced in the keyhole 11, the control paddle 20 cannot be rotated to unlock the vehicle door 1 and consequently the control lever 31 cannot be rotated either to unlock the latch 30.

In particular the latch 30 may comprise electrical actuators which may be controlled by a remote key, not shown, activated by a driver through a remote control. In case a remote control is used to unlock the vehicle door 1, the fact that the control lever 31 is blocked also prevents unlocking of the latch 30 by the remote key.

Hence, in the second position of the stopper 40, the vehicle door 1 can neither be unlocked and nor can it be opened. In other words, the stopper 40 ensures the locking of the vehicle door 1 and at the same time ensures that the latch 30 cannot be moved to open the door 1.

Depending on the door 1 (right or left door) on which it is mounted, the control paddle can be configured to be rotated in a clockwise direction for locking the door 1, or configured to be rotated in an anticlockwise direction. The stopper 40 is ideally placed to intercept the rotational pathway of the control lever 31. FIG. 4a shows a stopper 40 whose blocking end 44 is arranged to block a control lever 31 having a clockwise rotational pathway and FIG. 4b shows a blocking end 44 arranged to block a control lever 31 with an anticlockwise rotational pathway.

The first position allowing rotation of the control lever 31 may correspond to a rest state of the stopper 40. The second position blocking the rotation of the control lever 31 may correspond to an active state of the stopper 40 in which said stopper 40 may interact with the control lever 31.

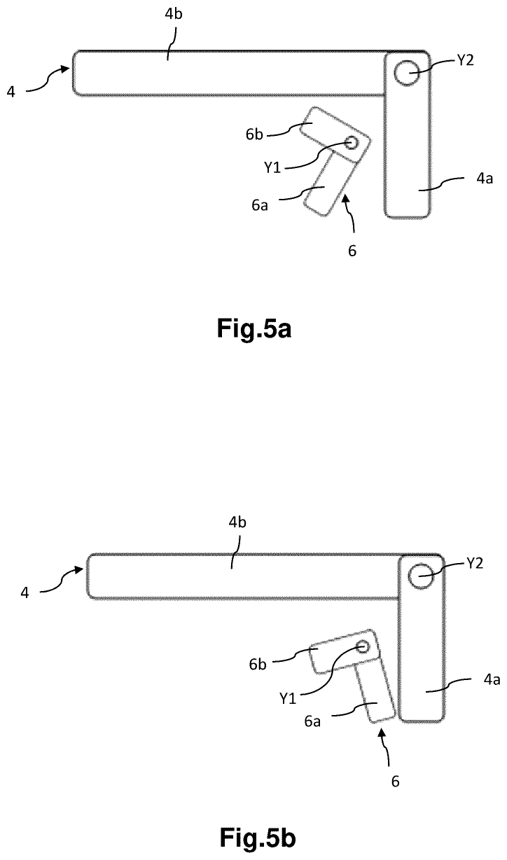

The inner door handle 4 is also configured to displace the stopper 40 in the first position when the inner handle 4 is rotated to open the door 1. According to an embodiment represented in FIGS. 5a to 5c, the stopper knob 6 comprises an actuation lever 6a which is displaced between a first position represented in FIG. 5a associated to the first position of the stopper 40 and a second position represented in FIG. 5b associated with the second position of the stopper 40. Thus, the first position corresponds to the unlocked position of the stopper knob 6 and the second position corresponds to the locked position of the stopper knob 6. The stopper knob 6 may be rotatably arranged around a first axis Y1 with a handling part 6b extending on one side and the actuation lever 6a extending on the other side. The handling part 6b and the actuation lever 6a may extend with an angle comprised between 70° and 100°, for example 90°, between each other.

The inner handle 4 also comprises a lever 4a which is configured for pushing the actuation lever 6a and makes the stopper knob 6 rotate towards its first position when the inner handle 4 is rotated as represented in FIG. 5c. The inner handle 4 may be rotatably arranged around a second axis Y2 parallel to the first axis Y1 with a handling part 4b extending on one side and the lever 4a extending on the other side. The handling part 4b and the lever 4a may extend with an angle comprised between 70° and 100°, for example 90°, between each other. Other mechanical arrangement may also be implemented to ensure the unlocking of the stopper 40 when the inner handle 4 is rotated.

Furthermore, the inner handle 4 is configured to displace the actuation lever 6a towards its first position before unlocking the door latch 30 and opening the door 1 via the Bowden cable 22′ when the inner handle 4 is rotated to open the door 1.

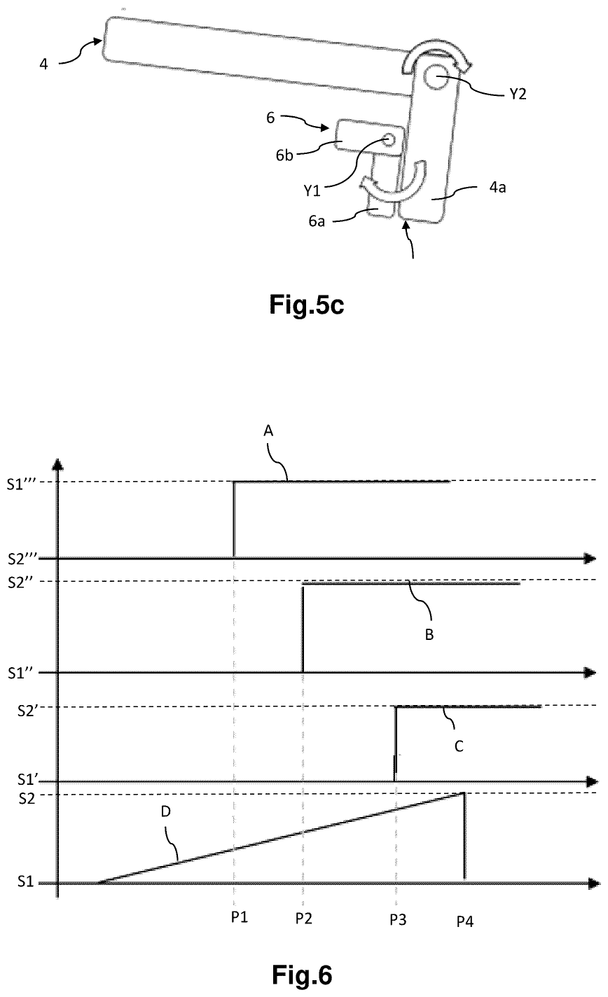

FIG. 6 represents a diagram of the evolution of the states of respectively the stopper 40 (curve A), the locking mechanism of the door latch 30 (curve B), the door 1 (curve C) and the inner handle 4 (curve D) when the inner handle 4 is rotated from a first state S1 corresponding to its rest position to a second state S2 associated with a fully rotated position. At a first rotation angle of the inner handle 4 noted P1, the stopper 40 is displaced from its second position noted S2″′ to its first position S1″′. Such displacement of the stopper 40 may be achieved thanks to the rotation of the actuation lever 6a of the stopper knob 6 as explained previously. At a second rotation angle of the inner handle 4 noted P2, the locking mechanism of the door latch 30 is unlocked. The locking mechanism is therefore switched from a first state S1″ associated with a locked position to a second state S2″ associated with an unlocked position. Such unlocking may be achieved via an electric signal or mechanically via a well-known mechanism. At a third rotation angle of the inner handle 4 noted P3, the door 1 is opened. Such opening is achieved thanks to the rotation of the control paddle 20 via the Bowden cable 22′ to release the latch fork 32 from the striker and allow the opening of the door 1.

Other mechanisms may be used to achieve the displacement of the stopper 40 towards its first position when the inner handle 4 is rotated.

The different Bowden cables 8, 22, 22′ and in particular the stopper Bowden cable 8 may be housed in a protective housing in order to prevent its access by introducing an object through the window seal.

Such arrangement allows the inner door handle 4 to move the stopper 40 into its first position to allow unlocking and opening of the vehicle door 1.

Hence, a supplemental actuation of the stopper knob 6 is not required if the driver inside the passenger cabin wishes to unlock and open the vehicle door 1. Nevertheless, if the driver only wishes to unlock the door 1 without opening it, the stopper knob 6 can be actuated to displace the stopper 40 into its first position without opening the vehicle door 1.

The present invention also refers to a vehicle door 1 comprising a vehicle door locking equipment 100 as described previously.

Thus, the present invention enables a user to prevent the opening of the door from the outside of the vehicle even with an authorized key. Furthermore, the present invention enables opening the door 1 from the inside by a simple rotation of the inner handle 4 as such rotation will trigger sequentially the release of the stopper 40, the unlocking of the door latch 30 and the opening of the door 1 which prevents from the risk of being locked outside when the driver exits its cabin and inadvertently forgets to unlock the stopper knob.

### REFERENCE LIST

100: Vehicle door locking equipment
1: Vehicle door
2: outer panel
3: inner panel
4: inner door handle
4a: inner door handle lever
5: outer door handle
6: stopper knob
6a: actuation lever
7: inner door handle frame
8: stopper Bowden cable
10: lock cylinder
20: control paddle
21: rod
22, 22′: Bowden cable
30: door latch
31: control lever
31A: rotational axis of control lever 31
311: base body
312: port
32: latch fork
40: stopper
40A: linear pathway of stopper
42: flat block
44: blocking end
50: housing
52: guide rails
D1: pulled direction
D2: pushed direction

1-10. (canceled).

11. Vehicle door locking equipment, comprising:
a door latch;
a lock cylinder configured to lock or unlock a vehicle door by rotating a control paddle linked to the door latch;
an inner handle linked to the door latch and configured to be rotated to allow an opening of the door from inside a passenger cabin;
a stopper knob located inside the passenger cabin; and
a stopper configured to be displaced between a first position allowing rotation of the control paddle and a second position allowing rotation of the control paddle upon actuation of the stopper knob,
wherein the inner handle is configured to displace the stopper in the first position when the inner handle is rotated to open the door.

12. The vehicle door locking equipment in accordance with claim 11, wherein the stopper knob comprises an actuation lever which is displaced between a first position associated to the first position of the stopper and a second position associated with the second position of the stopper, and wherein inner handle is configured to displace the actuation lever towards the first position of the actuation lever when the inner handle is rotated to open the door.

13. The vehicle door locking equipment in accordance with claim 11, wherein the rotation of the inner handle is configured to displace the stopper in the first position before unlocking the door latch and opening the door.

14. The vehicle door locking equipment in accordance with claim 13, wherein the inner handle is provided on an inner door handle frame, and wherein the stopper knob is arranged in the inner door handle frame.

15. The vehicle door locking equipment in accordance with claim 11, wherein the door latch and the stopper are housed in a common housing.

16. The vehicle door locking equipment in accordance with claim 11, wherein the door latch comprises a control lever configured to unlock the door latch, the control lever is linked to the control paddle of the lock cylinder and the stopper is in contact with the control lever in said second position.

17. The vehicle door locking equipment in accordance with claim 16, wherein the control lever is configured to rotate according to a rotational axis, and the stopper is configured to be displaced along a linear pathway which is substantially perpendicular to the rotational axis of the control lever.

18. The vehicle door locking equipment in accordance with claim 16, wherein the stopper comprises a blocking end which is configured to intercept the control lever of the door latch in said second position.

19. A vehicle door comprising:
the vehicle door locking equipment according to claim 11.

20. The vehicle door in accordance with claim 19, wherein the vehicle door is a side door.
